(19) United States
(12) Patent Application Publication
(10) Pub. No.: US 2017/0300109 A1
(43) Pub. Date: Oct. 19, 2017

(54) METHOD OF BLOWABLE USER INTERACTION AND AN ELECTRONIC DEVICE CAPABLE OF BLOWABLE USER INTERACTION

(71) Applicant: National Taiwan University, Taipei City (TW)

(72) Inventors: Wei-Hung CHEN, Taichung City (TW); Yuh-Jzer JOUNG, Taipei City (TW)

(21) Appl. No.: 15/099,263

(22) Filed: Apr. 14, 2016

(51) Int. Cl. G06F 3/01; G06F 3/0481; G06F 3/0346; G06F 3/0484; G06F 3/0482

(52) U.S. Cl. CPC G06F 3/011; G06F 3/04842; G06F 3/0482; G06F 3/017; G06F 3/0346; G06F 3/04817

(57) ABSTRACT

A method of blowable user interaction with an electronic device includes the steps of: displaying, by an output module, at least one icon which is activatable to invoke a corresponding function; generating, by the blow sensor, a sensing signal in response to detection of an input; after receiving the sensing signal from the blow sensor, controlling, by a control module according to the sensing signal thus received, the output module to output a feedback associated with the icon for notifying that the icon has been activated; and invoking, by the control module, the corresponding function associated with the icon.

### FIELD

The disclosure relates to a method and an electronic device, more particularly to a method of blowable user interaction, and an electronic device capable of blowable user interaction.

### BACKGROUND

In a conventional scheme of human-machine interaction, taking a smartphone as an example, a interact with the smartphone by touching a virtual button, an icon or an object displayed in the touchscreen.

Aside from a touch interface, another conventional scheme of human-machine interaction is implemented by a computer peripheral device, such as a computer mouse, a keyboard, an image recognition device, an optical sensor or an eye tracking device, for data input to control operation of a computer. However, for a disabled user, or for a user under some scenarios, such as when riding a bicycle, carrying weight with both hands, or holding onto a handrail, while riding an escalator, it is difficult to operate the aforementioned computer peripheral device to interact with an electronic device. Therefore, conventional schemes of human-machine interaction are insufficient for satisfying the needs for a fast, convenient and hands-free input method.

### SUMMARY

Therefore, an object of the disclosure is to provide a method of blowable user interaction with an electronic device, and an electronic device capable of blowable user interaction.

According to a first aspect of the disclosure, the method of blowable user interaction with an electronic device is to be implemented by the electronic device which includes an output module, a control module and at least one blow sensor. The method includes the steps of:

displaying, by the output module, at least one icon which is activatable to invoke a corresponding function of the electronic device;

generating, by the blow sensor, a sensing signal in response to detection of an input;

after receiving the sensing signal from the blow sensor, controlling, by the control module according to the icon corresponding to the sensing signal thus received, the output module to output a feedback associated with the icon for notifying that the icon has been activated; and

invoking, by the control module, the corresponding function associated with the icon which has been activated.

According to a second aspect of the disclosure, the electronic device capable of blowable user interaction includes at least one blow sensor, a control module and an output module. The at least one blow sensor is configured to generate a sensing signal in response to detection of an input. The control module is coupled electrically to the at least one blow sensor. The output module is coupled electrically to the control module and is configured to display at least one icon which is activatable to invoke a corresponding function of the electronic device. The control module is programmed to:

after receiving the sensing signal from the blow sensor, according to the sensing signal thus received, control the output module to output a feedback associated with the icon for notifying that the icon has been activated; and

invoke the corresponding function associated with the icon which has been activated.

An effect of the disclosure resides in that, by virtue of a blow sensor corresponding to an icon, a corresponding function associated with the icon can be activated by a blow from a user serving as the input, so that a disabled user or a user whose hands are occupied in some circumstances may be provided with an auxiliary control interface and may have a distinct user experience.

### BRIEF DESCRIPTION OF THE DRAWINGS

Other features and advantages of the disclosure will become apparent in the following detailed description of embodiment(s) with reference to the accompanying drawings, of which:

FIG. 1 is a block diagram illustrating an embodiment of an electronic device capable of blowable user interaction according to the disclosure;

FIG. 2 is a schematic diagram illustrating an embodiment of the electronic device which is exemplified as a smartwatch;

FIG. 3A is a schematic diagram illustrating an embodiment of the electronic device which is exemplified as a smartwatch displaying seven icons in a two-by-two grid system;

FIG. 3B is a schematic diagram illustrating an embodiment of another image containing the two-by-two grid system;

FIG. 3C is a schematic diagram illustrating an embodiment of the electronic device wherein the number of blow sensors is different from the number of zones being displayed;

FIG. 4 is a flow chart illustrating a first embodiment of a method of blowable user interaction with an electronic device according to the disclosure;

FIG. 5 is a flow chart illustrating a second embodiment of the method of blowable user interaction with an electronic device according to the disclosure;

FIG. 6 is a schematic diagram illustrating an embodiment of the electronic device which is exemplified as a smartwatch where icons corresponding to zoom-in/zoom-out functions are displayed;

FIG. 7 is a flow chart illustrating an embodiment of certain sub-steps of the method of blowable user interaction according to the disclosure; and

FIG. 8 is a schematic diagram illustrating different frequency responses of sensing signals generated by a blow sensor in response to inputs of human voice and a blow from the user.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

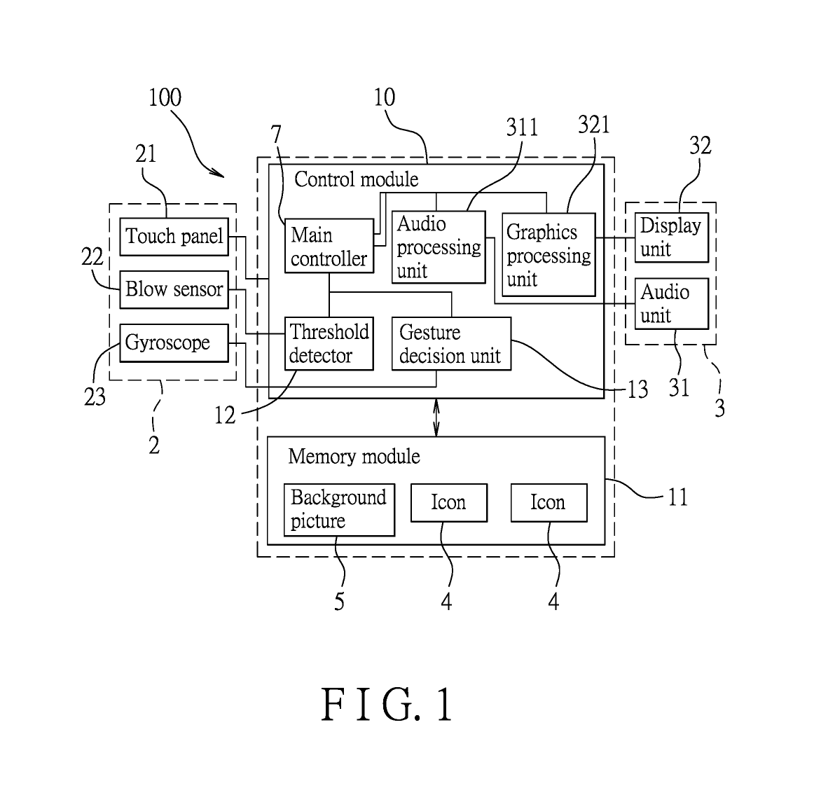

Referring to FIG. 1, a block diagram illustrates an embodiment of an electronic device 100 capable of blowable user interaction according to the disclosure. The electronic device 100 includes an input module 2, an output module 3, and a control module 10 interconnecting the input module 2 and the output module 3. In this embodiment, the electronic device 100 is exemplified as a smartwatch to be operated by a user. However, in other embodiments, the electronic device 100 is not limited to a smartwatch, and may be an electronic product, such a personal computer, a laptop computer, an ultraportable laptop, a netbook, a palmtop computer, an embedded computer, a smartphone, a wearable device and so forth.

The input module 2 includes a touch panel 21 for ordinary touch input operation, at least one blow sensor 22 and a gyroscope 23. The blow sensor 22 is exemplified as a microphone in this embodiment. The output module 3 includes a display unit 32, and an audio unit 31. In one embodiment, the touch panel 21 may be integrated with the display unit 32 to form a touchscreen. The control module 10 includes a main controller 7, a threshold detector 12 coupled electrically to the main controller 1 and the at least one blow sensor 22 of the input module 2, a gesture decision unit 13 coupled electrically to the main controller 7 and the gyroscope 23 of the input module 2, a graphics processing unit 321 coupled electrically to the main controller 7 and the display unit 32 of the output module 3, and an audio processing unit 311 coupled electrically to the main controller 7 and the audio unit 31 of the output module 3.

The electronic device 100 further includes a memory module 11 which is coupled electrically to the control module 10 and which stores at least one interactable graphic element (referred to as a plurality of icons 4 hereinafter) and a background picture 5 to be displayed by the display unit 32 when a method of blowable user interaction is performed using the electronic device 100. In an alternative embodiment of this disclosure, the background picture 5 is optional; that is, the background picture 5 may be omitted.

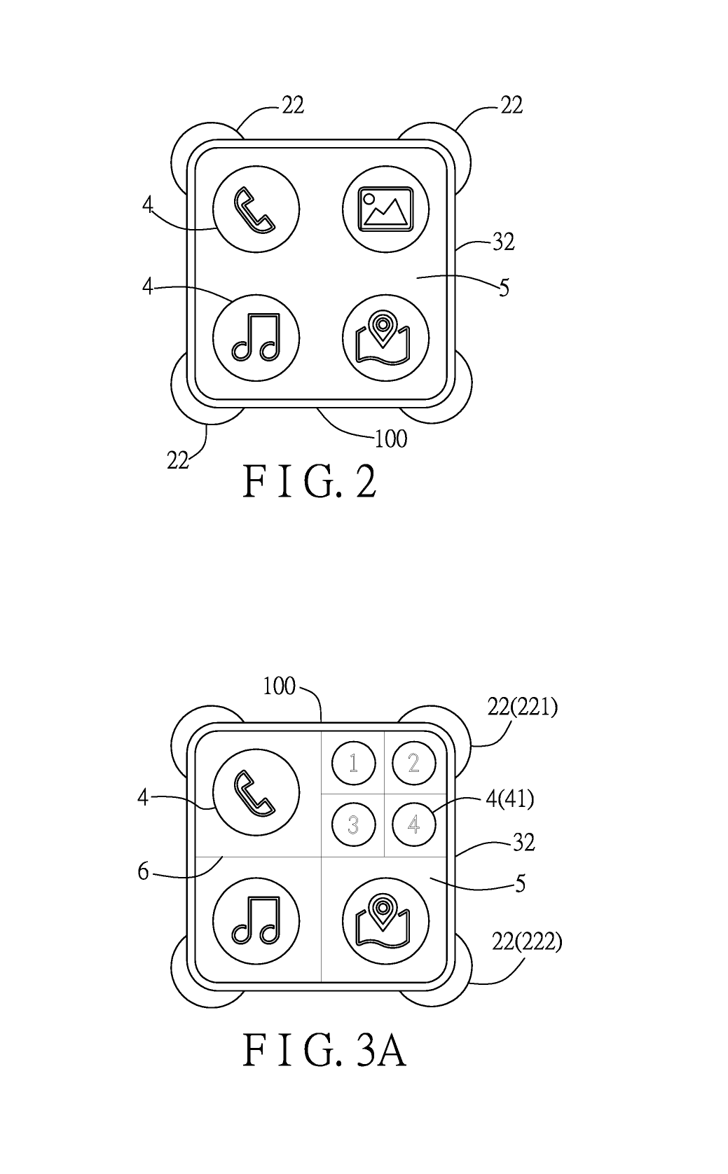

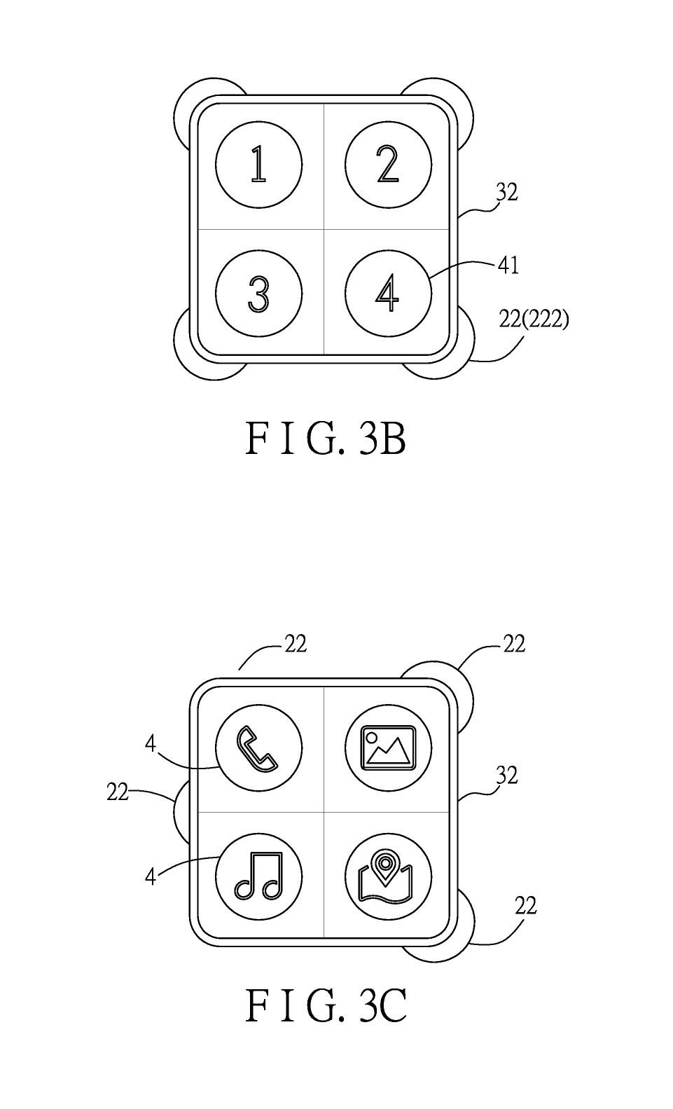

Referring to FIG. 1 to FIG. 3A, the display unit 32 displays an image containing a two-dimensional grid system having the plurality of icons 4 arranged therein, and containing the background picture 5 overlaid by the icons 4. Specifically, the grid system has (M) number of rows and (N) number of columns of grids where (M) and (N) represent natural numbers, and a number of the blow sensors 22 is equal to a product of (M) and (N) (see FIG. 2, (M) and (N) are each equal to two). Moreover, when a number of the icons 4 to be displayed is greater than the number of the blow sensors 22, at least one of the grids of the grid system is divided into (M) rows and (N) columns of sub-grids (see FIG. 3, where the grid at the upper right corner includes four, i.e., two-by-two, sub-grids), and the icons 4 are arranged in the sub-grids as well as the grids other than the at least one of the grids which is divided. In the example depicted in FIG. 3A, a plurality of blow sensors 22 are is disposed adjacent to a peripheral of the display unit 32. Note that FIG. 2 and FIG. 3 only illustrate exemplary images displayed by the display unit 32, and it is readily known to a skilled person in the art that a different number of possibly different icons 4 may be arranged in the grid system displayed by the display unit 32. It should also be appreciated that the grid system may be replaced with a zone system, in which the image is divided into a plurality of zones, which may be arbitrarily arranged (as opposed to being arranged in rows and columns) to suit a particular design, which may or may not be further divided into sub-zones, depending upon the number of icons 4 and the number of zones.

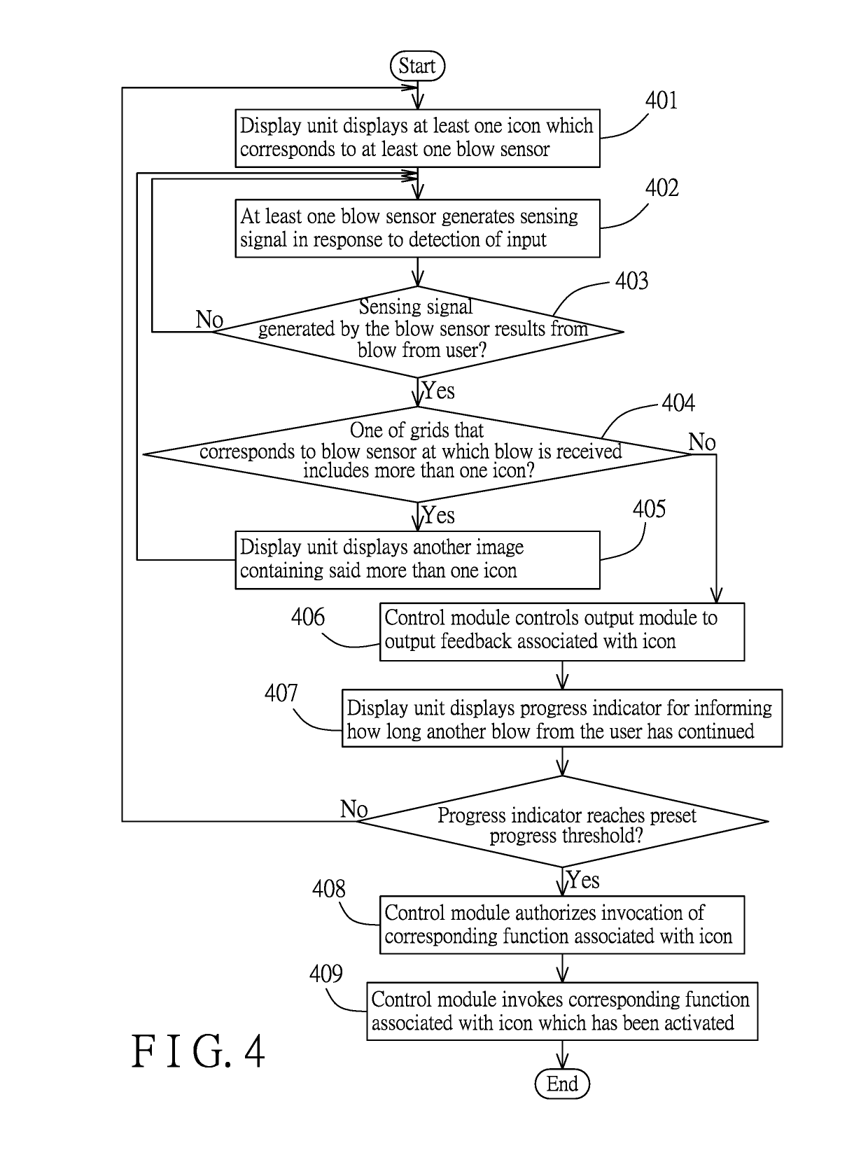

Referring to FIG. 4, a first embodiment of the method of blowable user interaction according to the disclosure is illustrated, where a user first blows air into one of the blew sensors 22 to activate a corresponding one of the icons 4, and then the user continuously blows at said one of the blow sensors 22 so as to enable the control module 10 to confirm that it is the corresponding one of the icons 4 the user intends to activate. The first embodiment of the method includes the following steps.

In step 401, the display unit 32 of the output module 3 displays at least one icon 4 which corresponds to the at least one blow sensor 22, and which is activatable to invoke a corresponding function of the electronic device 100. In one embodiment, the at least one blow sensor 22 is multiple in number, and the display unit 32 displays an image containing the grid system (M-by-N grids) having arranged therein a plurality of icons 4 each of which corresponds to one of the multiple blow sensors 22, and each of which is activetable to invoke a respective function of the electronic device 100 (see FIG. 2).

In step 402, one of the blow sensors 22 generates a sensing signal in response to detection of an input. Specifically, the blow sensors 22 operate based, on the piezoelectric effect (i.e., an internal generation of electrical charge resulting from an applied mechanical force, variation in pressure, acceleration, temperature or strain). In this embodiment, said one of the blow sensors 22 (referred to as the blow sensor 22 hereinafter) is configured to convert the input detected into a pressure signal to serve as the sensing signal.

In step 403, the control module 10 determines whether the sensing signal generated by the blow sensor 22 results from a blow from the user. In this step, since generation of the pressure signal may not only be caused by a blow from the user, but may also be falsely caused by the user's voice or touch, the control module 10 is required to determine whether the sensing signal is actually generated as a result of a blow from the user (i.e., whether the input is a blow from the user).

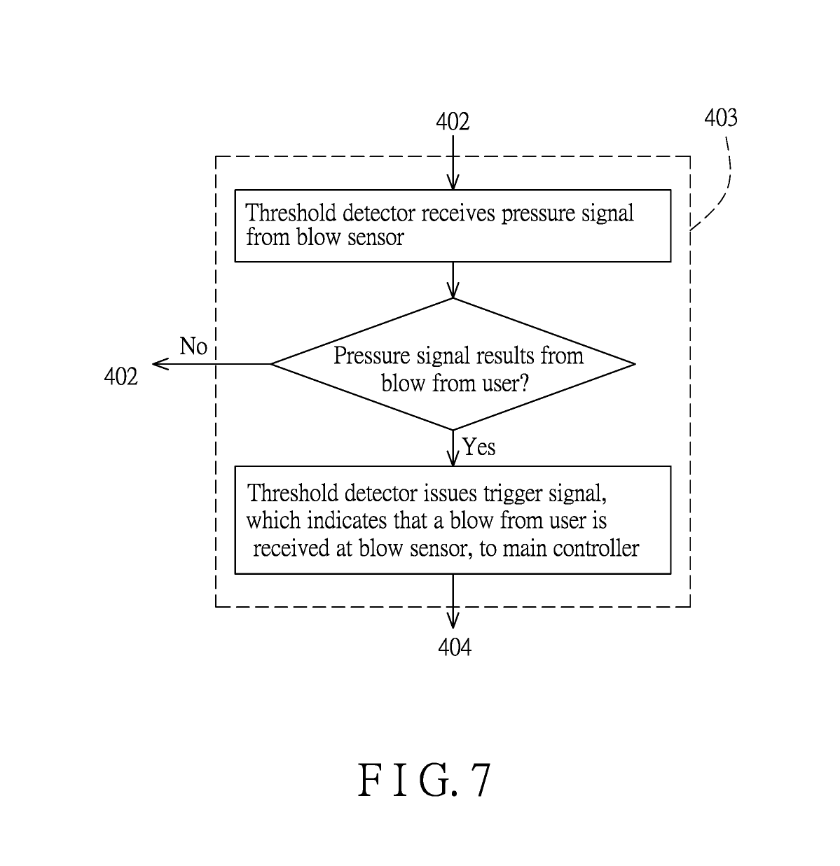

Therefore, referring to FIG. 7, step 403 includes the following sub-steps. The threshold detector 12 of the control module 10 receives the pressure signal from the blow sensor 22. The threshold detector 12 determines based on variation in the pressure signal whether or not the pressure signal results from a blow of the user. When it is determined that the pressure signal results from a blow of the user, the threshold detector 12 issues a trigger signal, which indicates that a blow is received from the user at the blow sensor 22, to the main controller 7, and the flow proceeds to step 404. Otherwise, when it is determined that the pressure signal does not result from a blow of the user, it means that the user does not intend to activate one of the icons 4 and thus does not purposefully blow air into the blow sensor 22, and the flow goes back to step 402. More specifically, for determining whether or not the pressure signal results from a blow of the user, the threshold detector 12 first calculates an average and the standard deviation of the pressure signal to obtain calculated values, and compares the calculated values with preset thresholds so as to decide whether or not the pressure signal results from a blow of the user based on a result of the comparison. In this embodiment, when the calculated values are greater than the preset thresholds, a conclusion may be made that the user blows air into the blow sensor 22. In one embodiment, the average of the pressure signal is obtained by calculating power peaks of the pressure signal, and performing a moving average.

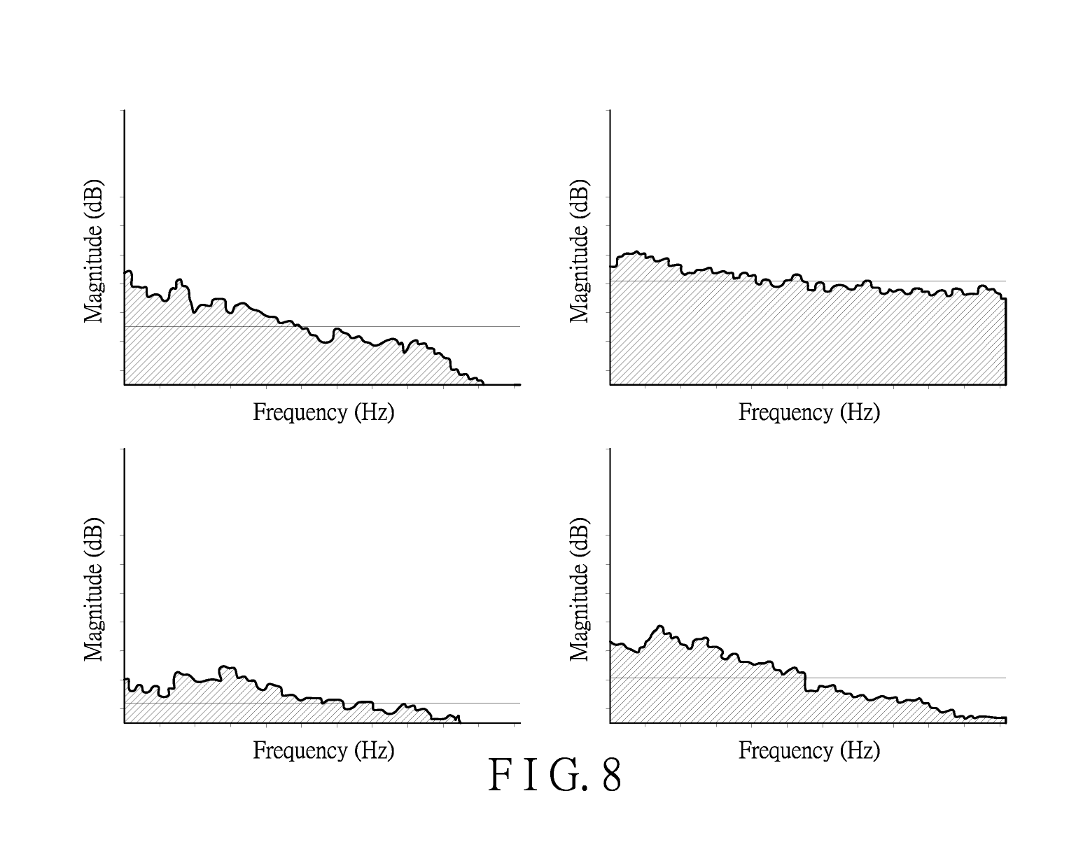

It should be noted that in other embodiments, the discrimination between human voice and a blow from the user (i.e., a blow voice) based on the sensing signal may be made in another fashion. For example, since the human voice is mostly composed of low frequency components, and a blow voice is equally mixed with components of all frequencies, the blow voice is able to be distinguished from the human voice by analyzing the frequency components of the sensing signal in the frequency domain. Referring to FIG. 8, an example of four frequency responses of the sensing signal generated by the blow sensor 22 in response to detection of inputs of human voice and a blow from the user is illustrated. The oscillogram at the upper right corner represents the frequency response of the sensing signal generated in response to detection of a blow which has a relatively even distribution for all frequencies, while the other three oscillograms each represent a frequency response of the sensing signal generated in response to detection of human voice which has stronger low frequency components compared to high frequency components.

In step 404, the control module 10 determines whether one of the grids, which corresponds to the blow sensor 22 at which the blow is received, includes more than one icon 4. When it is determined that said one of the grids does not include more than one icon 4 (i.e., includes only one icon 4), the flow proceeds to the step 406; otherwise, i.e., when it is determined that said one of the grids includes multiple icons 4, step 405 is performed.

In step 405, the display unit 32 displays another image containing the grid system (M-by-N grids) having arranged therein the multiple icons 4 corresponding to the blow sensor 22 at which the blow is received, and the flow goes back to step 402.

For example, referring to FIG. 3A, seven icons 4 are arranged in the two-by-two grid system contained in an image displayed by the display unit 32 (step 401). When the user intends to activate the icon number four 41 in the image, an iterative operation may be performed to activate the icon 41. The user first blows air into a blow sensor 221 at the upper right corner to select the grid at the upper right corner. As a result, the electronic device 100 performs steps 402 and 403 where a sensing signal is generated and a corresponding determination that the sensing signal is a result of a blow from the user is made. After the control module 10 determines that there are multiple icons (i.e., icon number one, icon number two, icon number three, and icon number four) in the grid at the upper right corner (i.e., step 404), the display unit 32 displays another image containing the two-by-two grid system having the icon 41 and the other icons arranged therein (i.e., step 405) (see FIG. 3B). The another image displayed in step 405 may be recognized as a second layer compared with the image displayed in step 401 which may be recognized as a first layer. At this moment, the user blows air into a blow sensor 222 at the lower right corner corresponding to the icon number four 41 at the lower left corner of the another image, next the blow sensor 222 generates a corresponding sensing signal in step 402, then the control module 10 determines that this sensing signal results from a blow from the user in step 403, after that the control module 10 determines that the icon 41 is the only icon in the grid at the lower right corner in step 404, and last the flow proceeds to step 406. If should be noted that FIGS. 3A and 3B merely illustrate an example showing the iterative operation. In practice, a different number of icons, grids and blow sensors may be adopted, and more layers may be displayed to realize the iterative operation.

In step 406, the control module 10 controls, according to said one of the icons 4 (referred to as the icon 4 hereinafter) corresponding to the blow sensor 22 at which the latest sensing signal is received, the output module 3 to output a feedback associated with the icon 4 for notifying that the icon 4 has been activated by the blow from the user.

Specifically, the main controller 7 of the control module 10 controls the display unit 32 via the graphics processing unit 321 to display a visual feedback associated with the icon 4 for confirmation by the user as to whether the icon 4 with which the visual feedback is associated is the icon the user intends to activate. The visual feedback in this embodiment is exemplified as a change in color, a change in shape or a displacement of the icon 4. Subsequently, the control module 10 may authorize invocation of the corresponding function associated with the icon 4 when the control module 10 determines that a confirmation is made in response to receipt of another blow from the user by the blow sensor 22.

In the first embodiment of the method, aside from displaying the visual feedback associated with the icon 4 in step 406, in step 407, the display unit 32 further displays a progress indicator for informing how long the another blow from the user has continued. It should be noted that since signal processing associated with the another blow is similar to that of the blow from the user recited in steps 402 and 403, detailed description of the same is omitted herein for the sake of brevity. Moreover, in step 408, the control module 10 authorizes the invocation of the corresponding function associated with the icon 4 when the progress indicator reaches a preset progress threshold for determining that the confirmation is made. That is to say, the control module 10 verifies the user's intent to activate the icon 4, so the control module 10 authorizes the invocation of the corresponding function of the icon 4. Otherwise, when the progress indicator does not reach the preset progress threshold, it means that the confirmation is not made, for example, the user falsely triggers the blow sensor 22, and thus the step goes back to step 401.

In step 409, the control module 10 invokes the corresponding function associated with the icon 4 which has been activated. The corresponding function may be an event to be handled by the electronic device 100, such as switching a page under navigation, zoom-in/zoom-out, answering the phone, reading a text message, browsing photos, playing music and so forth.

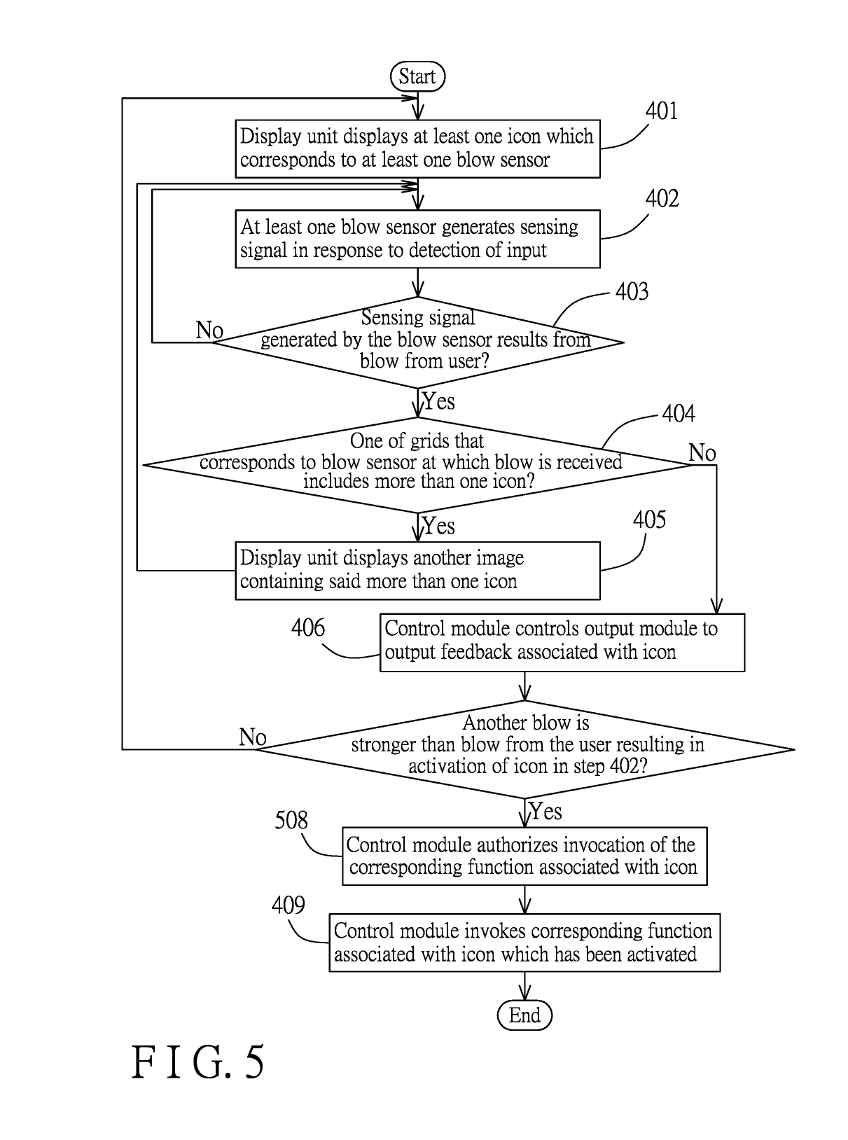

Referring to FIG. 5, a second embodiment of the method of blowable user interaction according to the disclosure is illustrated, where a user first blows air into one of the blow sensors 22 to activate a corresponding one of the icons 4, and then the user makes a stronger blow into said one of the blow sensors 22 so as to enable the control module 10 to confirm that it is the corresponding one of the icons 4 the user intends to activate. The second embodiment of the method is similar to the first embodiment, but is different in that the second embodiment does not include steps 407 and 408, and instead includes step 508.

Subsequent to step 406, in step 508, the control module 10 authorizes the invocation of the corresponding function associated with the icon 4 when the control module 10 determines that the confirmation is made in response to receipt from the user by the blow sensor 22 of the another blow, which is stronger than the blow from the user for activation of the icon 4 in step 402. It should be noted that signal processing associated with the another blow is similar to that of the blow from the user recited in steps 402 and 403. However, since the another blow should be stronger than the blow from the user for activation of the icon 4 in step 402, a preset confirmation threshold which is higher than the preset threshold is adopted while making a similar determination as that made in step 403.

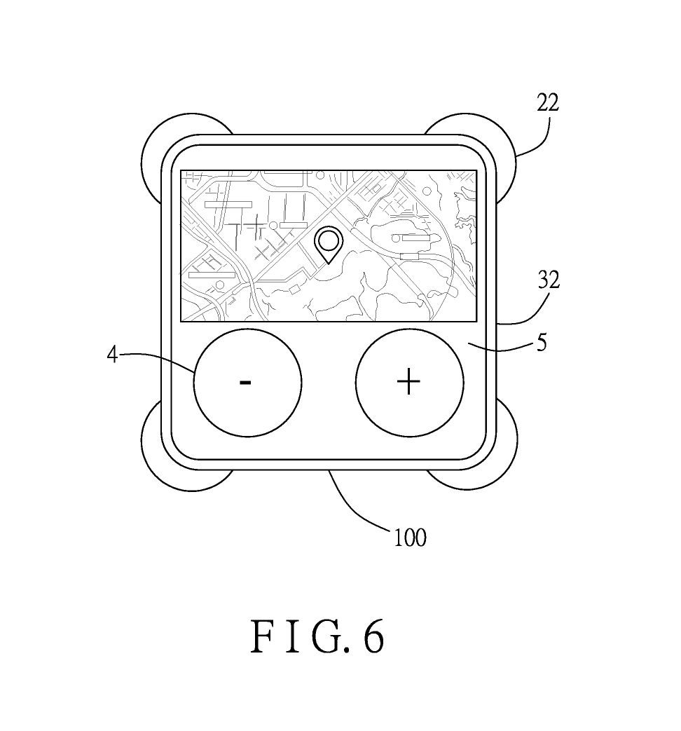

Furthermore, in an embodiment of the electronic device 100 according to the disclosure, the gyroscope 23 is configured to measure rotation of the electronic device 100. Specifically, the gyroscope 23 generates an angular data associated with a result of measurement of rotation of the electronic device 100. The angular data is processed and analyzed by the gesture decision unit 13 of the control module 10. The control module 10 is configured to modify, according to the angular data generated by the gyroscope 23, the corresponding function associated with the icon 4 which has been activated. For example, referring to FIG. 6, when the user blows air into the blow sensor 22 in combination with rotating the wrist wearing the electronic device 100 (e.g., a smartwatch), a scale in which a zoom-in operation is performed during browsing of an electronic map may be adjusted, so as to achieve an effect of further control of the electronic device 100. In other embodiments, the angular data may be used to modify movement of an object, variation in numerical values and so forth.

In addition, in step 406, where the control module 10 controls the output module 3 to output the feedback, the feedback is not limited to a visual feedback, and may be an audible feedback, such as a voice notification or a ring tone for notifying that the icon 4 has been activated by the blow from the user. In this scenario, the main controller 7 controls the audio unit 31 (e.g., a loudspeaker) via the audio processing unit 311 to play the voice notification or the ring tone.

Referring to FIG. 3C, in one embodiment of the electronic device 100, the number of the blow sensors 22 is not necessarily equal to the number of the grids of the grid system (or zones of the zone system). In this instance, three blow sensors 22 are utilized for activation of four icons 4 arranged respectively in four grids of the grid system. By virtue of analyzing three sensing signals respectively generated by the three blow sensors 22 in response to detection of an input of a same blow from the user, a direction from which the user blows at the electronic device 100 or a position at which the user blows at the electronic device 100 is obtained, so as to determine which one of the four icons 4 the user intends to activate.

It should be noted that, in one embodiment of this disclosure, the trigger signal which indicates that a blow from the user is received at the blow sensor 22 in step 403 is similar to a trigger signal generated in response to a touch input by the user using the touch panel 21 for activating the icon 4. The method of blowable user interaction may be performed in combination with other computer peripherals, such as a computer mouse, a keyboard, an image recognition device, an optical sensor or an eye tracking device, for data input to control operation of the electronic device 100. Moreover, activation of the icon 4 in the method of blowable user interaction is not limited to a unidirectional signal blow as mentioned above, and may be implemented through other types of blow input in combination with the motion of the electronic device 100, such as double blows, a long blow, a swipe blow, a blow around the device, a blow and tilt of the device, a blow and rotation of the device and so forth.

Further example embodiments are provided hereinafter.

Example 1 is a method of blowable user interaction with an electronic device. The method is to be implemented by the electronic device which includes an output module, a control module and at least one blow sensor. The method includes the steps of:

displaying, by the output module, at least one icon which is activatable to invoke a corresponding function of the electronic device;

generating, by the blow sensor, a sensing signal in response to detection of an input;

after receiving the sensing signal from the blow sensor, controlling, by the control module according to the sensing signal thus received, the output module to output a feedback associated with the icon for notifying that the icon has been activated; and

invoking, by the control module, the corresponding function associated with the icon which has been activated.

Example 2 includes the subject matter of Example 1, where the at least one blow sensor is multiple in number. The output module includes a display unit. In the step of displaying at least one icon, the display unit displays an image containing a two-dimensional zone system having the plurality of icons arranged therein. The zone system has (M) number of zones and (M) is a natural number.

Example 3 includes the subject matter of Example 2, where in the step of displaying at least one icon, when a number of the icons to be displayed is greater than the number of the zones, at least one of the zones of the zone system is divided into subzones which constitute a subzone system, and the icons are arranged in the zones other than said at least one of the zones and the subzones.

Example 4 includes the subject matter of Example 3, where subsequent to the step of generating a sensing signal, the method further includes the steps of:

determining, by the control module, whether one of the zones which contains one of the icons to be activated according to the sensing signals generated respectively by the blow sensors includes more than one of the icons;

when it is determined that said one of the zones includes more than one of the icons, displaying, by the display unit, another image containing the subzone system having said more than one of the icons arranged therein, and the flow going back to the step of generating a sensing signal; and

when it is determined that said one of the zones does not include more than one of the icons, the flow proceeding to the step of controlling the output module to output a feedback.

To sum up, in the method of blowable user interact ion according to the disclosure, by determining whether the sensing signal generated by the blow sensor 22 results from a blow from the user, the icon 4 corresponding to the blow sensor 22 may be activated by a simple blow action from the user, so as to enable the electronic device 100 to invoke the corresponding function. Moreover, a duration or an intensity of another blow input from the user may be used for confirming the user's intent to activate the icon 4. In this way, hands-free interaction between the user and the electronic device 100 is realized by virtue of at least, one blow input according to the method of the disclosure.

In the description above, for the purposes of explanation, numerous specific detail s have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of blowable user interaction with an electronic device, the method to be implemented by the electronic device which includes an output module, a control module and at least one blow sensor, the method comprising the steps of:
displaying, by the output module, at least one icon which is activatable to invoke a corresponding function of the electronic device;
generating, by the blow sensor, a sensing signal in response to detection of an input;
after receiving the sensing signal from the blow sensor, controlling, by the control module according to the sensing signal thus received, the output module to output a feedback associated with the icon for notifying that the icon has been activated; and
invoking, by the control module, the corresponding function associated with the icon which has been activated.

2. The method of claim 1, the control module includes a threshold detector,
wherein the step of generating a sensing signal includes converting, by the blow sensor, the input into a pressure signal to serve as the sensing signal;
prior to the step of controlling the output module to output a feedback, the method further comprising the step of determining, by the control module, whether the sensing signal generated by the blow sensor results from a blow from the user, which includes the sub-steps of
receiving, by the threshold detector, the pressure signal from the blow sensor,
determining, by the threshold detector based on the pressure signal, whether or not the pressure signal results from a blow from the user, and
issuing, by the threshold detector, a trigger signal which indicates that a blow is received from the user at the blow sensor when it is determined that the pressure signal results from a blow from the user.

3. The method of claim 2, wherein the sub-step of determining whether or not the pressure signal results from a blow from the user includes the sub-steps of:
calculating, by the threshold detector, an average and the standard deviation of the pressure signal to obtain calculated values; and
comparing, by the threshold detector, the calculated values with preset thresholds so as to decide whether or not the pressure signal results from a blow from the user based on a result of the comparison.

4. The method of claim 1, the output module including a display unit, wherein the step of controlling the output module to output a feedback includes the sub-steps of:
controlling, by the control module, the display unit to display a visual feedback associated with the icon for confirmation by the user as to whether the icon with which the visual feedback is associated is the icon which the user intends to activate; and
authorizing, by the control module, invocation of the corresponding function associated with the icon when the control module determines that a confirmation is made in response to receipt of another blow from the user by the blow sensor.

5. The method of claim 4,
wherein the step of controlling the output module to output a feedback further includes the sub-step of displaying, by the display unit, a progress indicator for informing how long the another blow from the user has continued; and
wherein, in the sub-step of authorizing invocation of the corresponding function, the invocation of the corresponding function associated with the icon is authorized when the progress indicator reaches a preset progress threshold for determining that the confirmation is made.

6. The method of claim 4,
wherein, in the sub-step of authorizing invocation of the corresponding function, the invocation of the corresponding function associated with the icon is authorized when the control module determines that the confirmation is made in response to receipt of the another blow from the user which is stronger than the blow from the user resulting in the activation of the icon.

7. The method of claim 1, the at least one blow sensor being multiple in number, the output module including a display unit, wherein, in the step of displaying at least one icon, the display unit displays an image containing a two-dimensional cone system having a plurality of the icons arranged therein, the zone system having (M) number of zones where (M) is a natural number.

8. The method of claim 7, wherein, in the step of displaying at least one icon, when a number of the icons to be displayed is greater than the number of the zones, at least one of the zones of the zone system is divided into subzones which constitute a subzone system, and the icons are arranged in the zones other than said at least one of the tones and the subzones.

9. The method of claim 8, subsequent to the step of generating a sensing signal, further comprising the steps of:
determining, by the control module, whether one of the zones which contains one of the icons to be activated according to the sensing signals generated respectively by the blow sensors includes more than one of the icons;
when it is determined that said one of the zones includes more than one of the icons, displaying, by the display unit, another image containing the subzone system having said more than one of the icons arranged therein, and the flow going back to the step of generating a sensing signal; and
when it is determined that said one of the zones does not include more than one of the icons, the flow proceeding to the step of controlling the output module to output a feedback.

10. The method of claim 1, the electronic device further including a gyroscope for measuring rotation of the electronic device, the method, subsequent to the step of invoking the corresponding function associated with the icon, further comprising the steps of:
generating, by the gyroscope, an angular data associated with a result of measurement of rotation of the electronic device; and
modifying, by the control module according to the angular data generated by the gyroscope, the corresponding function associated with the icon which has been activated.

11. An electronic device capable of blowable user interaction, the electronic device comprising:
at least one blow sensor configured to generate a sensing signal in response to detection of an input;
a control module coupled electrically to the at least one blow sensor; and
an output module coupled electrically to the control module and configured to display at least one icon which is activatable to invoke a corresponding function of the electronic device;
wherein the control module is programmed to
after receiving the sensing signal from the blow sensor, according to the sensing signal thus received, control the output module to output a feedback associated with the icon for notifying that the icon has been activated, and
invoke the corresponding function associated with the icon which has been activated.

12. The electronic device of claim 11,
wherein the control module includes a threshold detector;
wherein the blow sensor is configured to convert the input received into a pressure signal to serve as the sensing signal; and
wherein the control model is further programmed to determine whether the sensing signal generated by the blow sensor results from a blow from the user by
receiving, by the threshold detector, the pressure signal from the blow sensor,
determining, by the threshold detector based on the pressure signal, whether or not the pressure signal results from a blow from the user, and
issuing, by the threshold detector, a trigger signal which indicates that a blow is received from the user at the blow sensor when it is determined that the pressure signal results from a blow from the user.

13. The electronic device of claim 12, wherein the threshold detector is configured to:
calculate an average and the standard deviation of the pressure signal to obtain calculated values; and
compare the calculated values with preset thresholds so as to decide whether or not the pressure signal results from a blow from the user based on a result of the comparison.

14. The electronic device of claim 11,
wherein the output module includes a display unit; and
wherein the control module is further programmed to
control the display unit to display a visual feedback associated with the icon for confirmation by the user as to whether the icon with which the visual feedback is associated is the icon which the user intends to activate, and
authorize invocation of the corresponding function associated with the icon when the control module determines that a confirmation is made in response to receipt of another blow from the user by the blow sensor.

15. The electronic device of claim 14,
wherein the display unit is configured to display a progress indicator for informing how long the another blow from the user has continued; and
wherein the invocation of the corresponding function associated with the icon is authorized when the progress indicator reaches a preset progress threshold for determining that the confirmation is made.

16. The electronic device of claim 14,
wherein the invocation of the corresponding function associated with the icon is authorized when the control module determines that the confirmation is made in response to receipt of the another blow from the user which is stronger than the blow from the user resulting in the activation of the icon.

17. The electronic device of claim 11,
wherein the at least one blow sensor is multiple in number;
wherein the output module includes a display unit; and
wherein the display unit is configured to display an image containing a two-dimensional zone system having a plurality of the icons arranged therein, the zone system having (M) number of zones where (M) is a natural number.

18. The electronic device of claim 17, wherein, when a number of the icons to be displayed is greater than the number of the zones, at least one of the zones of the zone system is divided into subzones which constitute a subzone system, and the icons are arranged in the zones other than said at least one of the zones and the subzones.

19. The electronic device of claim 18,
wherein the control module is further programmed to determine whether one of the zones which contains one of the icons to be activated according to the sensing signals generated respectively by the blow sensors includes more than one of the icons;
wherein, when it is determined that said one of the zones includes more than one of the icons, the display unit displays another image containing the subzone system having said more than one of the icons arranged therein, and the flow going back to the step of generating a sensing signal; and
wherein, when it is determined that said one of the zones does not include more than one of the icons, the control module controls the output module to output the feedback.

20. The electronic device of claim 11, further comprising a gyroscope for measuring rotation of the electronic device, the gyroscope being configured to generate an angular data associated with a result of measurement of rotation of the electronic device; and
wherein the control module is further programmed to modify, according to the angular data generated by the gyroscope, the corresponding function associated with the icon which has been activated.
